(19) United States
(12) Patent Application Publication
(10) Pub. No.: US 2017/0308868 A1
(43) Pub. Date: Oct. 26, 2017

(54) Community Resource Allocation

(71) Applicant: Mambo, LLC, Dallas, TX (US)

(72) Inventor: Deanna Charles, Dallas, TX (US)

(73) Assignee: Mambo, LLC, Dallas, TX (US)

(21) Appl. No.: 15/496,788

(22) Filed: Apr. 25, 2017

Related U.S. Application Data
(60) Provisional application No. 62/327,217, filed on Apr. 25, 2016.

(51) Int. Cl. G06Q 10/10; G06Q 50/00

(52) U.S. Cl. CPC G06Q 10/1095; G06Q 50/01

(57) ABSTRACT

A community activity and event coordination platform is provided that is based on a centrally managed platform that can be used in any community (school, university, retirement village, etc.) to connect community members through activities and events. The event coordination platform may be hosted on a server that is configured to send and receive information about one or more events available to the community. Furthermore, the event coordination platform may allow the community to submit a suggested event for posting and allow any member of the community to sign up for an event from their electronic computing device via the server. Additionally, the event coordination platform may include an administrative module that provides an administrative interface for administrative personnel to monitor events posted to the event coordination platform.

### RELATED APPLICATION

The present application claims priority to U.S. Provisional Patent Application No. 62/327,217, which is herein incorporated by reference in its entirety for all that it shows, teaches and suggests, without exclusion of any part thereof.

### TECHNICAL FIELD

The present disclosure is related generally to mobile communication devices, and, more particularly, to a system and method for modifying a communication mode of a mobile communication device based on user speech characteristics.

### BACKGROUND

Although the internet and the explosion of smaller networks and community sites have led to increased opportunities for users to share ideas and for small groups of users to coordinate activities, there is still no easy way for members of a community at large to seamlessly coordinate community activities and events. For example, while one person may text another person that they know and set up a tennis date, there is no convenient mechanism to allow users who are not yet known to one another to accomplish such a task. Moreover, as the group size needed for an activity rises, the complexity of scheduling such an activity in an ad hoc manner rises as well.

While the present disclosure is directed to a system that can eliminate certain shortcomings noted in or apparent from the above, it will be appreciated that such a benefit is neither a limitation on the scope of the disclosed principles nor of the attached claims, except to the extent expressly noted in the claims. Additionally, the discussion in this Background section is reflective of the inventors' own observations, considerations, and thoughts, and is not intended to catalog or summarize any item of prior art. As such, the inventors expressly disclaim this section as admitted or assumed prior art. Moreover, the identification or implication herein of a desirable course of action reflects the inventors' own observations and ideas, and therefore cannot be assumed to indicate an art-recognized desirability.

### SUMMARY

In keeping with an embodiment of the disclosed principles, a system is provided for creating a customized community experience via a network and multiple nodes. An administrative platform initially uploads information regarding resources and activities from one or more authorized users. The information regarding resources and activities is then made available to participants, e.g., students, retirees or other community members, these participants are able to select among customized categories to identify resources and activities in which they are interested. Categories may be, for example, “therapy” for retirees or “career” for students. At this point, the user's homepage view shows what resources and activities are trending overall within the community as well as in their particular categories of interests (e.g., followed under “my interests”).

With respect to generating the information to be uploaded, any person or party within the community who possesses a talent or skill may apply to create an activity. In an embodiment, this entails using an application on the system website that generates a description for administrative approval via the administrative platform. Posting users may upload their own photo to go with the activity description or may use other sources including a link to a free art site. Users create their own descriptions, set their own fees, and classify the posting, e.g., social, arts and crafts, etc.

The user is also able to use the post generation application to set the minimum and maximum number of participants for their event. In this way, if the minimum number is not reached by a predetermined deadline, the posting is simply deactivated by the system and the poster receives a notification, e.g., an email, to that effect. It may take 1-2 days for an activity to be approved and if the activity is approved, it is then added to the platform. Postings for recurring activities can be created as well using a pre-filled application. In an embodiment, activities created by administration need not wait for approval but rather are automatically approved.

In a further embodiment, once a user is following a category, activities arising within the followed category may be pushed to the user's phone. In addition to following one or more categories, users are also able to perform a more detailed filtering of posting by such terms as “free food”, “walk-in”, distance, time period, day, etc. Users may sign-up, save, or share the activity via social media or email, and the platform allows the user to view others who are signed up.

After the activity has passed, each attending user receives an evaluation form via a notification and rates the activity. The accumulated ratings allow the administrator to determine whether to allow the activity to recur.

In an embodiment, users are able to suggest activities that they would like to attend. In particular, an appropriate icon such as a lightbulb may be used by the user to submit any ideas they may have as to what should take place within the community.

In another embodiment, banners are supported to allow administrators to post alerts (e.g., hurricane is coming) or less urgent material (e.g., advertising). PDFs, links, and photos may be added to the banners and can reside on as many categories as the administrator chooses.

At any given time, the administrator is able to generate analytics reflective of what activities users enjoy within which categories. In this way, the administrator is able to identify any mismatches between their allocation of resources and the needs of their population.

Other features and aspects of embodiments of the disclosed principles will be appreciated from the detailed disclosure taken in conjunction with the included figures.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a schematic view of an electronic computing device environment within which embodiments of the disclosed principles may be implemented;

FIG. 2 is a flowchart of a process in accordance with an embodiment of the disclosed principles;

FIG. 3 is a screenshot in accordance with an embodiment of the disclosed principles;

FIG. 4 is a screenshot in accordance with an embodiment of the disclosed principles;

FIG. 5 is a screenshot in accordance with an embodiment of the disclosed principles;

FIG. 6 is a screenshot in accordance with an embodiment of the disclosed principles;

FIG. 7 is a screenshot in accordance with an embodiment of the disclosed principles;

FIG. 8 is a screenshot in accordance with an embodiment of the disclosed principles;

FIG. 9 is a screenshot in accordance with an embodiment of the disclosed principles;

FIG. 10 is a screenshot in accordance with an embodiment of the disclosed principles;

FIG. 11 is a screenshot in accordance with an embodiment of the disclosed principles;

FIG. 12 is a screenshot in accordance with an embodiment of the disclosed principles;

FIG. 13 is a screenshot in accordance with an embodiment of the disclosed principles;

FIG. 14 is a screenshot in accordance with an embodiment of the disclosed principles;

FIG. 15 is a screenshot in accordance with an embodiment of the disclosed principles;

FIG. 16 is a screenshot in accordance with an embodiment of the disclosed principles;

FIG. 17 is a screenshot in accordance with an embodiment of the disclosed principles;

FIG. 18 is a screenshot in accordance with an embodiment of the disclosed principles;

FIG. 19 is a screenshot in accordance with an embodiment of the disclosed principles;

FIG. 20 is a screenshot in accordance with an embodiment of the disclosed principles;

FIG. 21 is a screenshot in accordance with an embodiment of the disclosed principles;

FIG. 22 is a screenshot in accordance with an embodiment of the disclosed principles;

FIG. 23 is a screenshot in accordance with an embodiment of the disclosed principles;

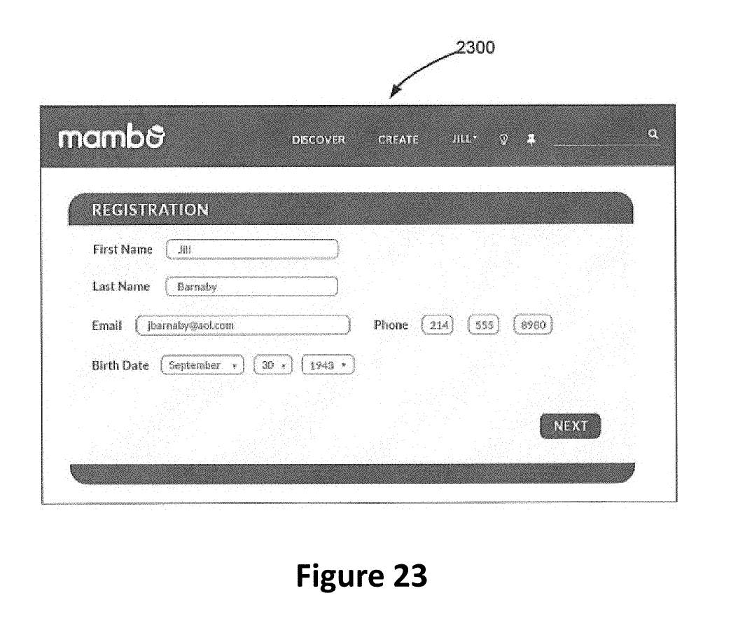

FIG. 24 is a screenshot in accordance with an embodiment of the disclosed principles;

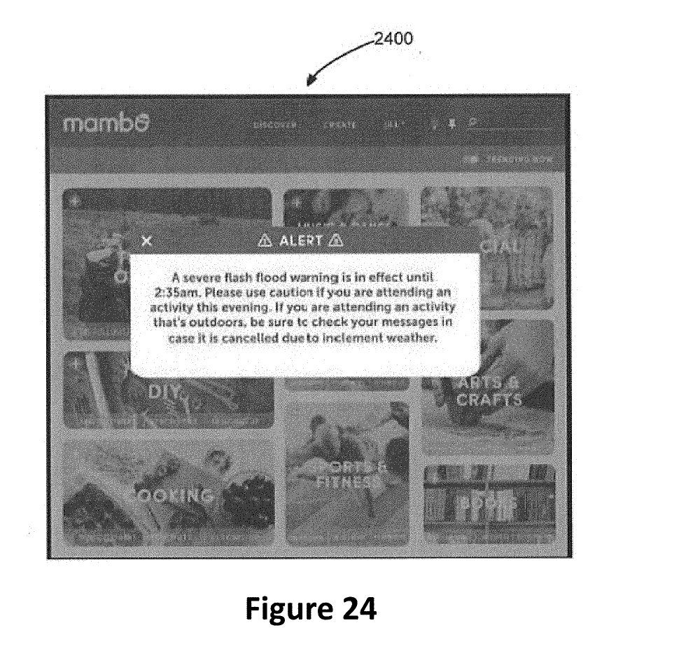

FIG. 25 is a screenshot in accordance with an embodiment of the disclosed principles; and

FIG. 26 is a screenshot in accordance with an embodiment of the disclosed principles;

FIG. 27 is a screenshot in accordance with an embodiment of the disclosed principles;

FIG. 28 is a screenshot in accordance with an embodiment of the disclosed principles;

FIG. 29 is a screenshot in accordance with an embodiment of the disclosed principles; and

FIG. 30 is a flowchart of a process in accordance with an embodiment of the disclosed principles.

### DETAILED DESCRIPTION

As noted above, although individuals are able to coordinate activities via interpersonal messaging etc., there is no convenient mechanism to allow users who are not yet known to one another to accomplish such a task. This is not an insurmountable hurdle, but does become nearly so when the number of participants needed for an activity rises to higher levels. Moreover, while certain specific activities may be centrally managed by a dedicated system (e.g., Comic-Con, The Indianapolis 500), there is no open and adaptable platform to allow many different activities of interest to the entire community to be centrally coordinated.

With this in mind, the disclosed principles provide a centrally managed system that can be used in any community (school, university, retirement village, etc.) to connect community members through activities and events. While the invention lends itself to many variations, certain embodiments will be discussed herein to aid the reader in understanding the attached claims.

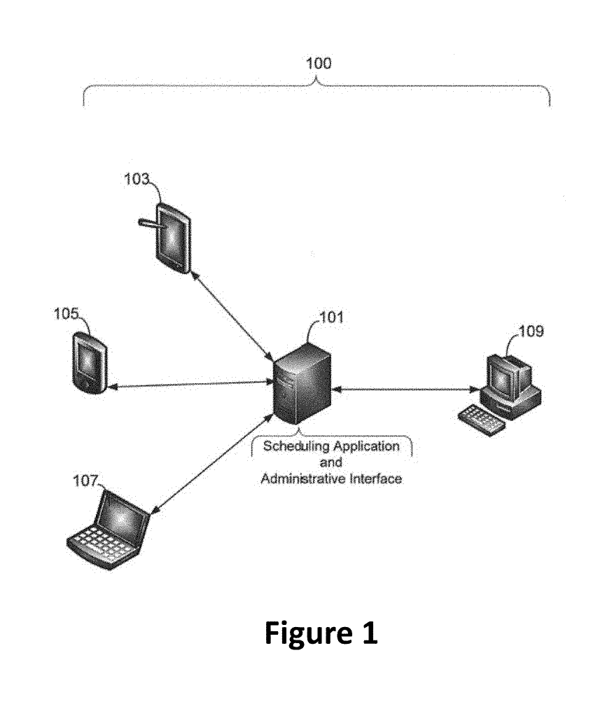

With this overview in mind, and turning now to a more detailed discussion in conjunction with the attached figures, the techniques of the present disclosure are illustrated as being implemented in a suitable computing and network environment. FIG. 1 shows an example of such an environment. In particular, the illustrated example 100 includes a server 101 as well as numerous user devices 103, 105, 107 and an administrative device 109. It will be appreciated that a greater or lesser number of user devices may be used and that more than one administrative device may be used, especially if there are numerous administrators in a system.

Each of the user devices 103, 105, 107 and the administrative device 109 may be any portable or stationary computing device capable of communicating electronically, e.g., via a wired or wireless network. Each user device 103, 105, 107 should also have user interface capabilities such that its user may observe information, e.g., on a screen of the device, and may input information, e.g., via a virtual or physical device key board.

In an embodiment, the collection of user devices 103, 105, 107 includes one or more of a smartphone device, a laptop device, a desktop PC, and a tablet. The administrative device 109 may also be any of these device types.

Each device has memory, e.g., RAM and ROM, and a processing unit, and executes computer-implemented tasks by retrieving computer-executable instructions from a non-transient computer-readable medium such as one or both of RAM and ROM or other memory structure, and executing the computer-executable instructions on the device processor. Thus, for example, the later flowcharts herein will refer to steps, and it will be appreciated that those steps which are computer-implemented on a device are executed in the above manner.

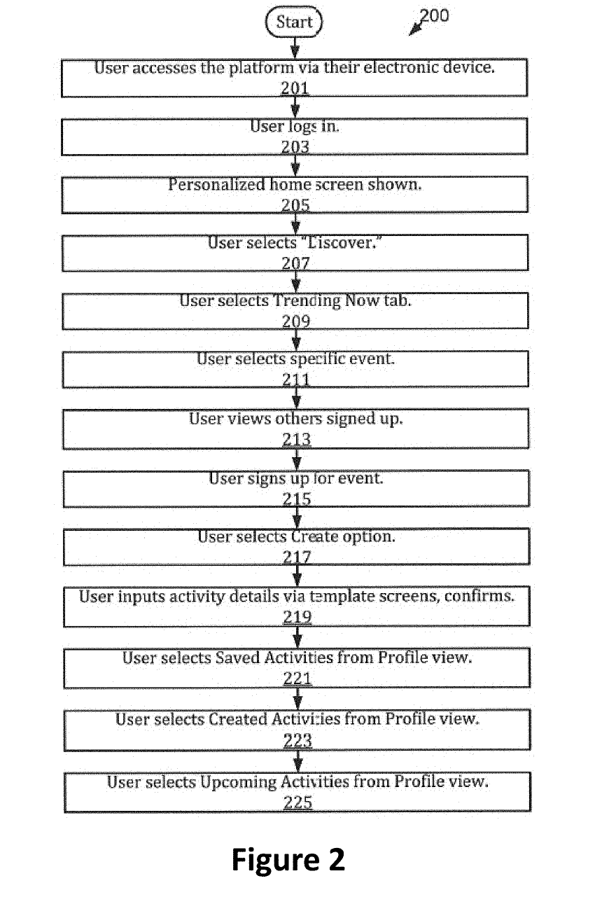

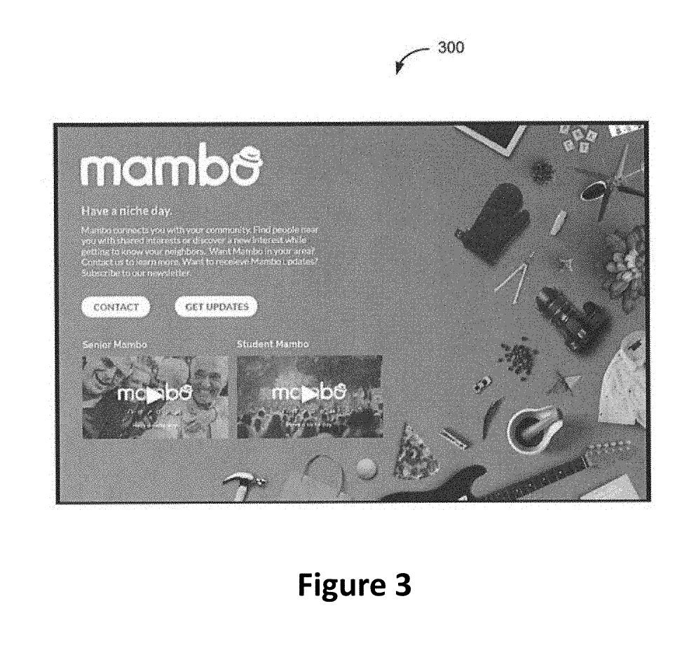

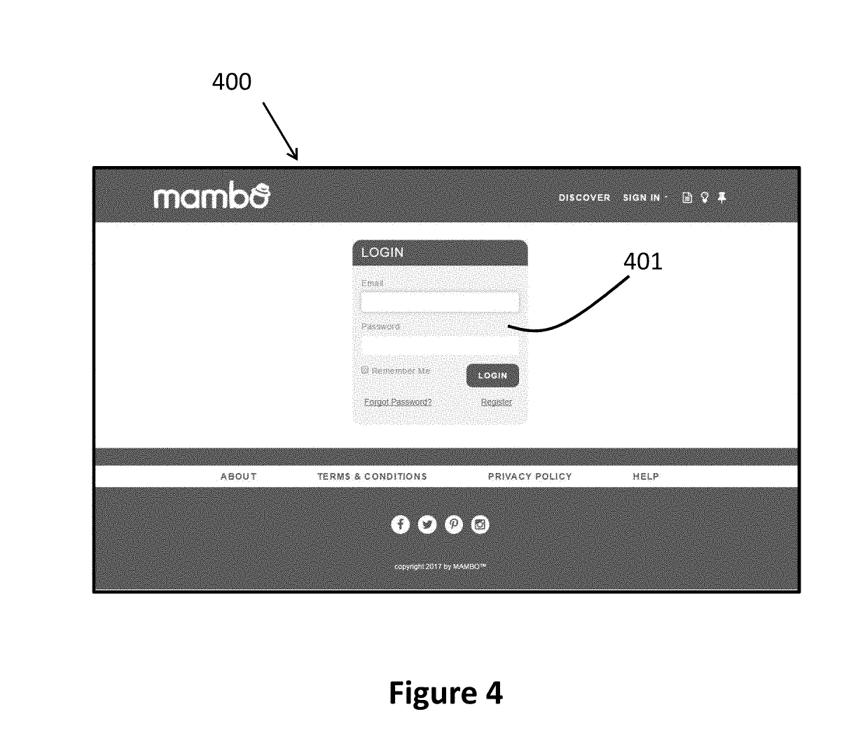

While providing more detailed screenshots corresponding to an implementation of the disclosed principles, several exemplary processes will be flowcharted to aid the reader. To this end, FIG. 2 shows a flow chart of a process 200 for submitting an idea for an activity or event. At stage 201 of the process, the user accesses the platform via their electronic device and lands on a home page 300 such as is shown in FIG. 3. Next at stage 203 the user logs in using the login screen 400 shown in FIG. 4. Assuming the user has already registered, i.e., created an account on the system; the user enters their email address and password into the login box 401. If the user needs to create an account they can do so using the Register link located at the bottom of the login box 401. The process is similar to traditional processes in that the user provides some basic information as well as a username and password.

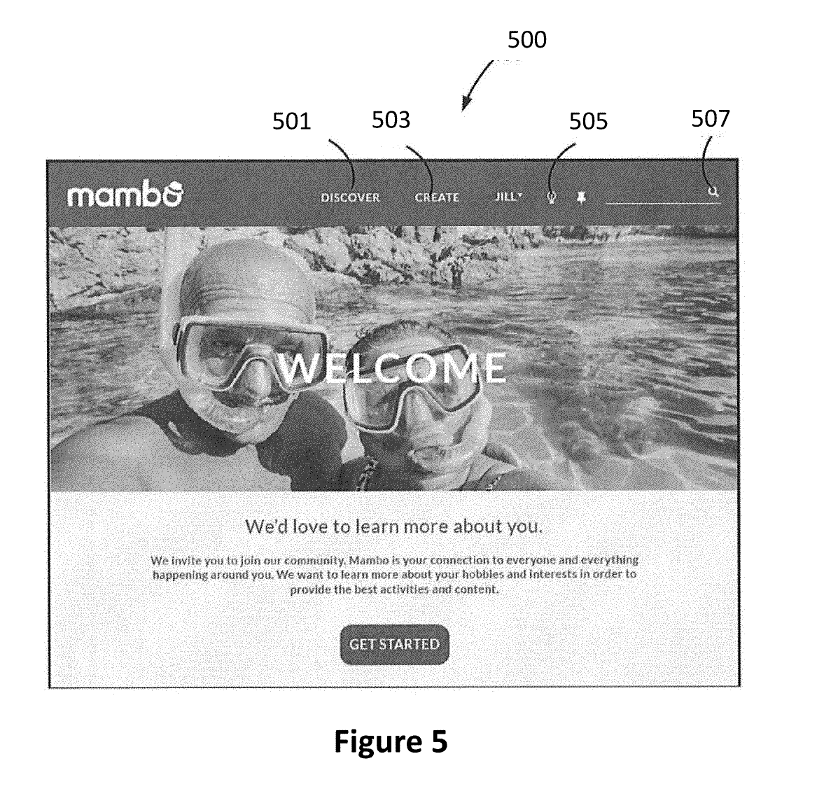

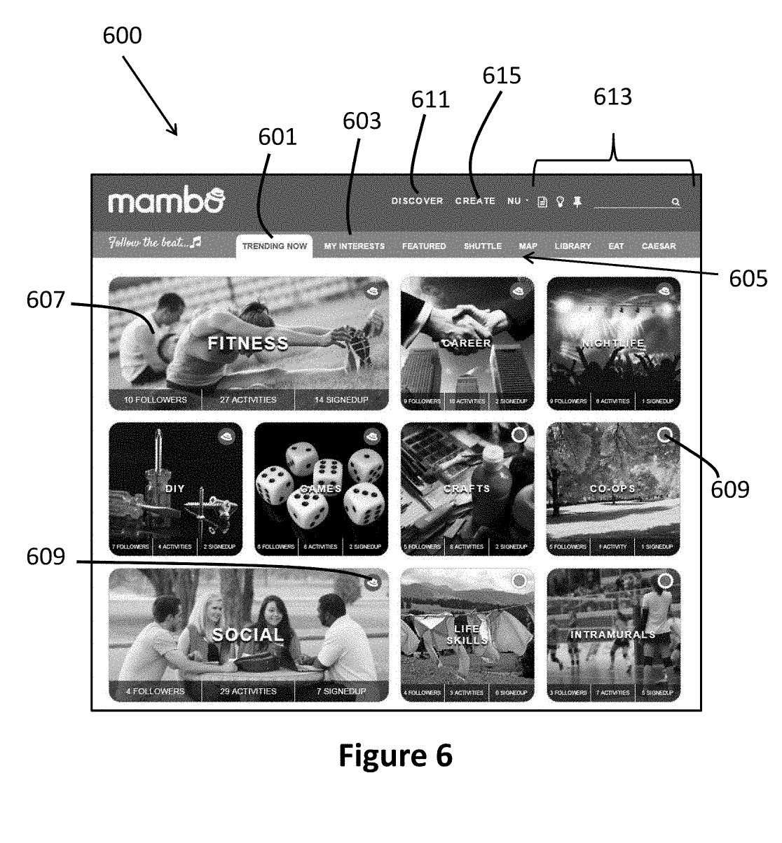

When the user has logged in, a personalized home page, such as the screen 500 of FIG. 5, is shown at stage 205. As can be seen in this view, the user can choose from among various options including Discover 501, Create 503, Submit an Idea 505 and Search 507. At stage 207, if the user selects Discover 501, they are taken to a Trending Now page 600 (FIG. 6) from which the user can view popular events and activities select their interests from among displayed interest and activity categories. Once a user has already logged in previously and selected interests, the personalized home page may appear as shown in FIG. 6.

As can be seen, the screen 600 includes a Trending Now tab 601, a My Interests tab 603, as well as a number of additional tabs 605 such as but not limited to, Featured, Shuttle, Map, Library, Eat, Caesar, and other such tabs. The Administrator may determine the number of tabs that are shown on screen 600 during the initial scheduling of the event in the scheduling application and administrative interface. Alternatively, the Administrator may edit the number of tabs shown on screen 600 at a different time. Moreover, the Administrator may set up the names of each individual tab as well as determine the desired information displayed when each tab is selected for viewing.

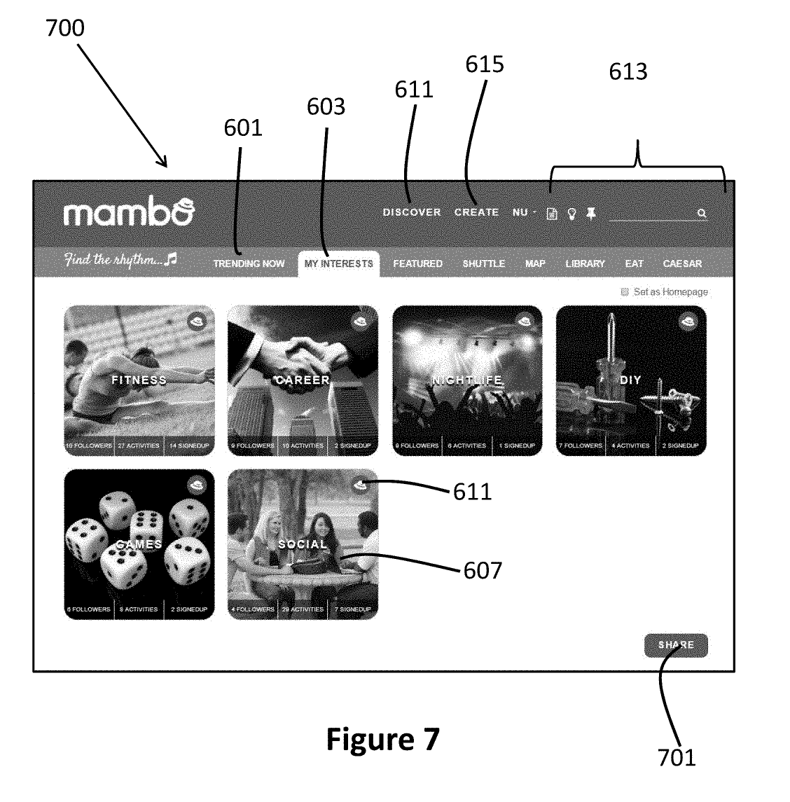

If the user selects the Trending Now tab 601, a listing of categories 607 is displayed on the screen 600. The categories 607 shown on the screen 600 may be ordered or otherwise ranked based on criteria such as, a number of followers, activities, signed up participants, or other such information related to each category 607. Alternatively, the Administrator may determine other relevant criteria that can be used to order each category 607 displayed under the Trending Now tab 601. Some embodiments of the screen 600 maybe configured to display each category 607 in a bubble that includes a selectable button 609. If a user is interested in one or more of the categories 607 then the user may activate the selectable button 609. Activating the selectable button 609 will display the selected category 607 under the My Interests tab 603, as shown in FIG. 7. Furthermore, if a user is no longer interested in a previously selected category 607 then the user may deactivate the selectable button 609. As a result, the deselected category will be removed the categories 607 displayed under the My Interests tab 603. The user may elect to view the categories 607 in a list or other such view rather than being displayed in bubble form.

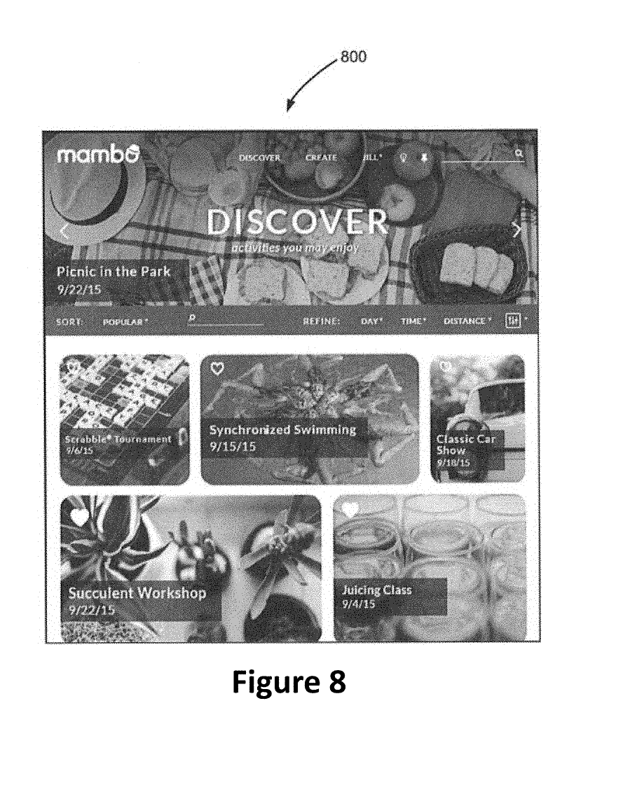

In some embodiments, the screen 600 may further include a Discover tab 611, and an information icon group 613 that includes a search bar, a bulletin board, an idea submission, and other such that icons may link or otherwise direct the user to additional information related to current activities and events. If at any screen the user selects the Discover tab 611 as in stage 207, the user is shown an array of currently scheduled events and activities. In the illustrated screen example 800 of FIG. 8, the options include Scrabble, Synchronized Swimming, a Car Show, a Succulents Workshop and a Juicing Class. It will be appreciated that other activities will typically be shown. In some cases, the Discover tab 611 may be configured to show currently scheduled events and activities that may be related to or correspond with prior events and activities selected by the user. For example, the scheduling application and administrative interface illustrated in FIG. 1 may incorporate machine learning or other such program capability that is executed by the server 101, numerous user devices 103, 105, 107, and/or the administrative device 109. As a result, in some embodiments, when the user selects the Discover tab 611, screen 800 may analyze the user's historical preferences and accordingly display and/or suggest upcoming events and activities based off prior selected events and activities.

Referring back to screen 700 shown in FIG. 7, the My Interests tab 603 may further include a Share button 701 that can be activated by the user. In an embodiment, the Share button 701 may be configured to send or otherwise broadcast the categories 607 that the user has selected in the My Interests tab 603. Moreover, the user may identify a set of other users or interested individuals that that are connected to the network environment 100 of FIG. 1. The Administrator, the user, or other such individual may configure the activation of the Share button 701 to transmit an electronic message (e.g., electronic mail, text message, notification, or other message) that shows the categories 607 the user has selected under the My Interests tab 603. User may select one of the categories that are listed under the My Interests tab 603.

Additionally, in some embodiments the Administrator or user may further may add additional tabs alongside the Trending Now tab 601, the My Interests tab 603, and other such tabs. For example, a My Activities tab may be added that merges events and activities from the My Interests tab 603. As a result, events and activities that span a variety of categories may be arranged into a personalized activity feed for each user. In some embodiments, the My Interests tab 603 may allow the user to identify key words and phrases within a category, and the key words and phrases may be used to create the personalized activity feed. For example, the user may identify the key word “yoga” within the “fitness” category to include all scheduled fitness events with the term “yoga” into the personalized activity feed.

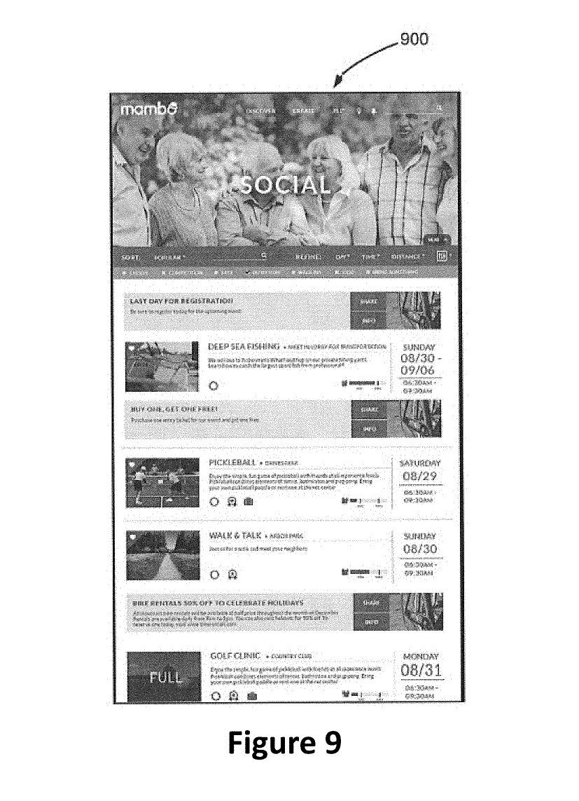

Furthermore, under the My Interests tab 603 the user may select one of the listed categories 607 in order to receive additional information. Screen 900 illustrated in FIG. 9, shows additional information related to the Social category 607. Screen 900 displays a listing of all the events that fall under the selected category 607 and allows the user to select one or more particular events.

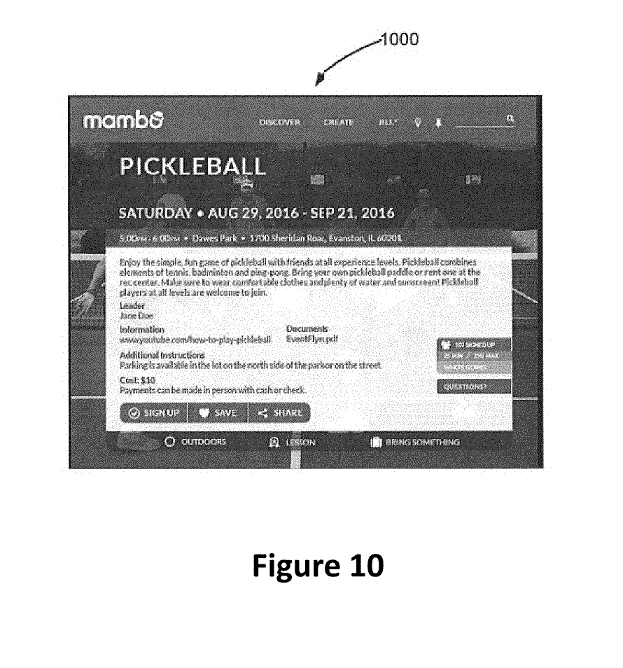

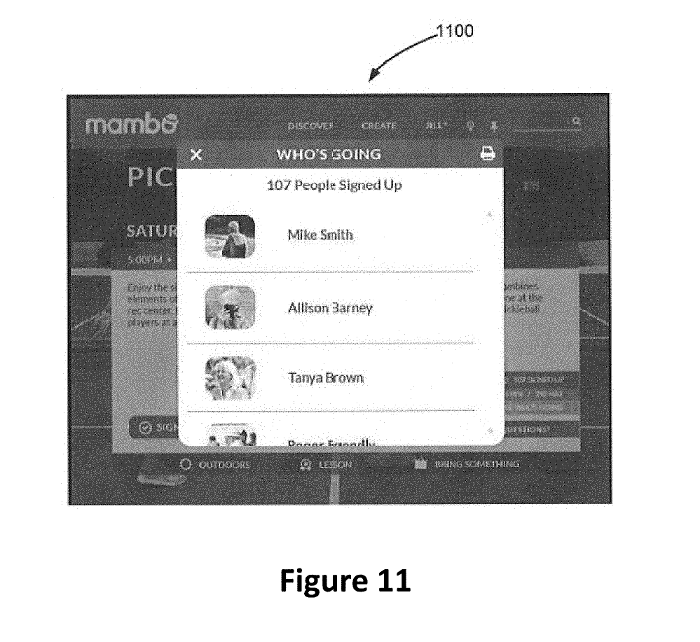

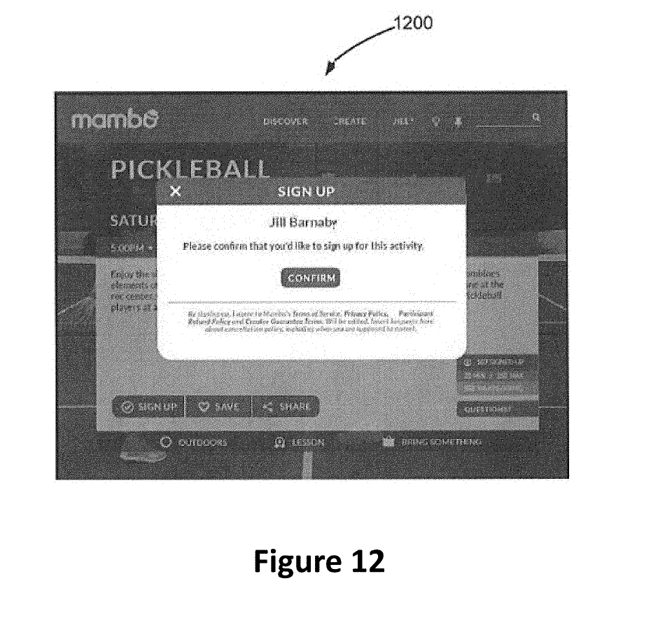

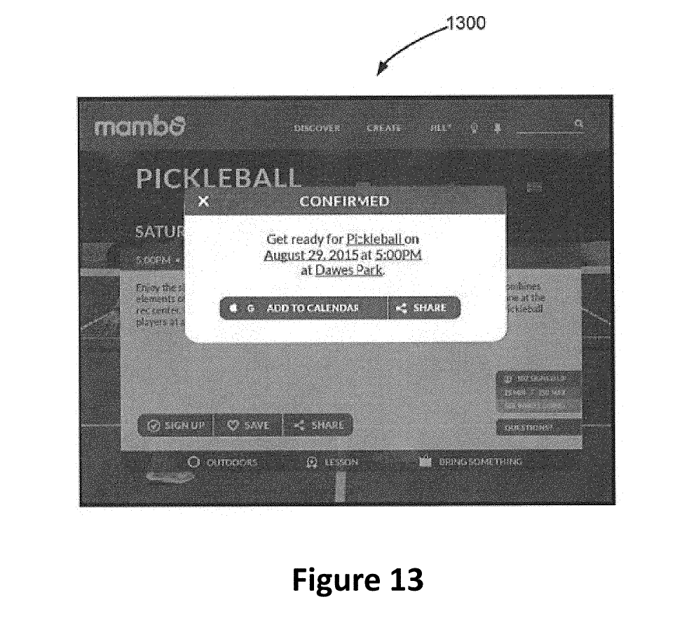

If the user selects a specific event, in this case Pickle Ball, at stage 211, then the user is shown a full page explanation of the selected event as shown in FIG. 10. As shown in FIG. 11, the user may elect at stage 213 to view which users are currently signed up for the event in question. In some embodiments, the Administrator may disable the ability to view which users are currently signed up for the event if the organizer of the event in question does not want to display such information. In the illustrated example, it can be seen that 107 people are already signed up for Pickle Ball. The user may then elect at stage 215 to sign up for the event (FIG. 12) and a confirmation may be shown (FIG. 13).

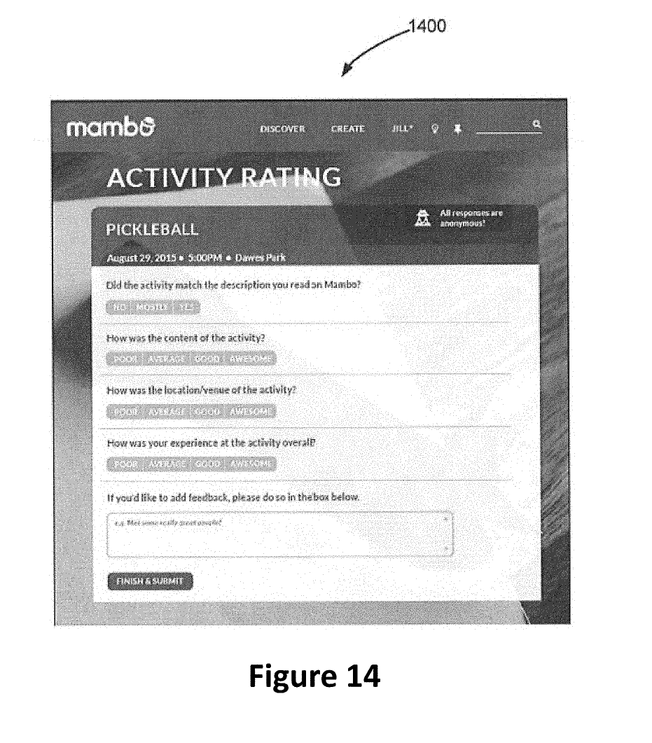

As noted above, the user may be given a chance to rate the activity after participating, as shown in FIG. 14. Although the rating criteria may very at the implementer's whim, the illustrated example shows accuracy of description, content, activity venue and overall impression. As a result, the Administrator or other interested individual may set up the rating criteria to accurately capture the desired feedback for a specific event.

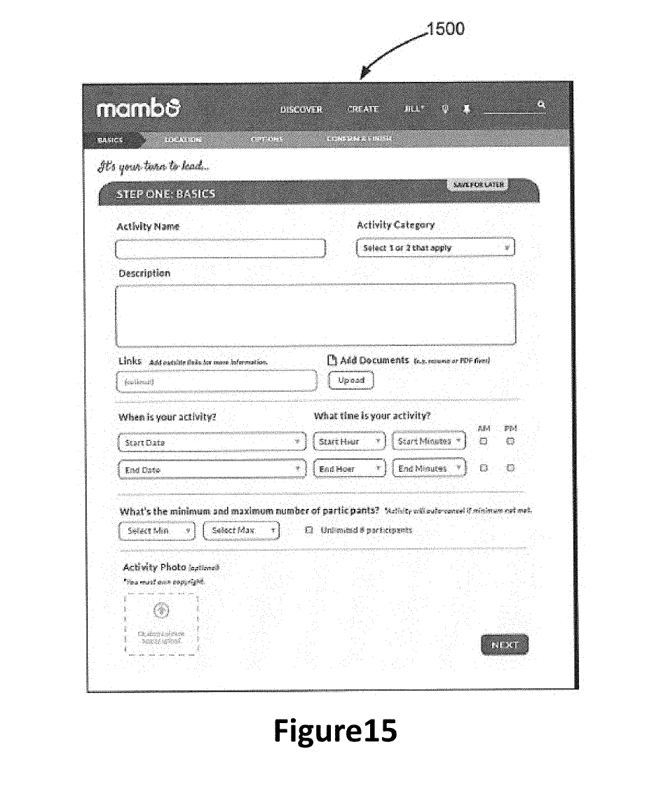

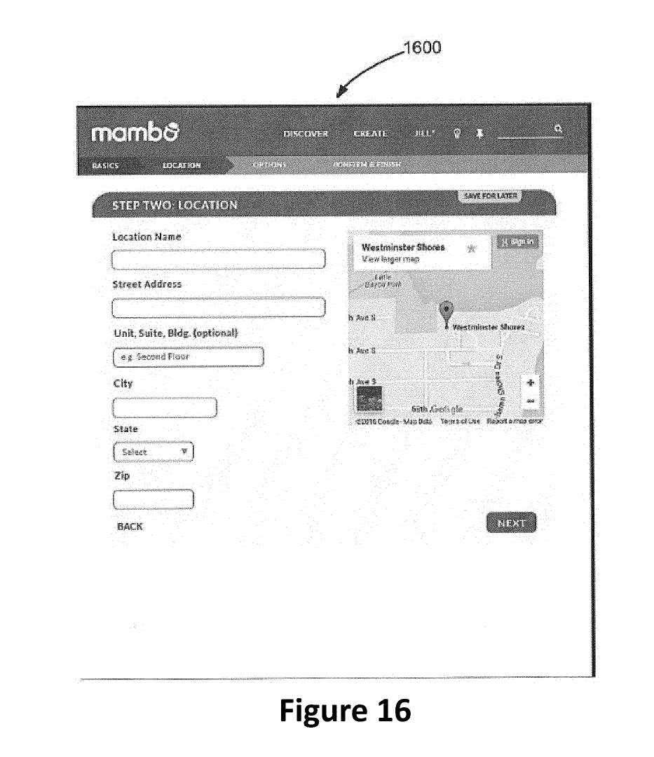

The user may choose to create an activity, e.g., using the Create option at stage 217. If so, the user is shown a creation template such as that shown in FIG. 15 and fills in a series of required information at stage 219. In particular, as shown in this example, the template may contain numerous fields such as description fields, scheduling fields and attendance limits (e.g., maximum and/or minimum attendance requirements). Continuing, the user is asked to fill in a second set of information, as shown in FIG. 16, i.e., location information.

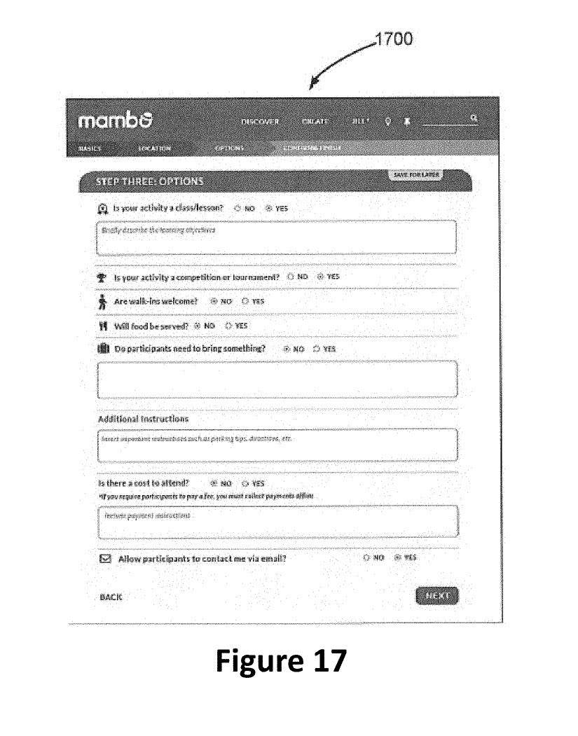

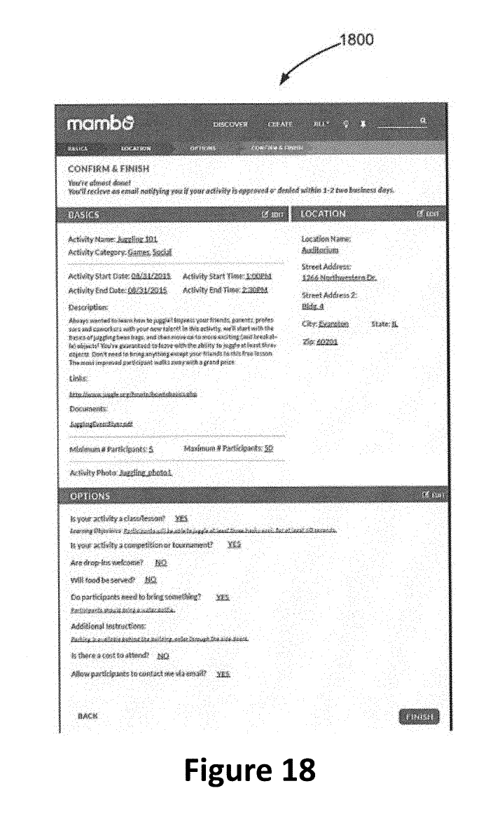

The user may then be asked to provide options information via a screen such as is shown in FIG. 17. Options information may include, for example, whether the session is a class/lesson, whether food will be served, and so on. Finally, the user may be asked to review and confirm their submission as shown in FIG. 18.

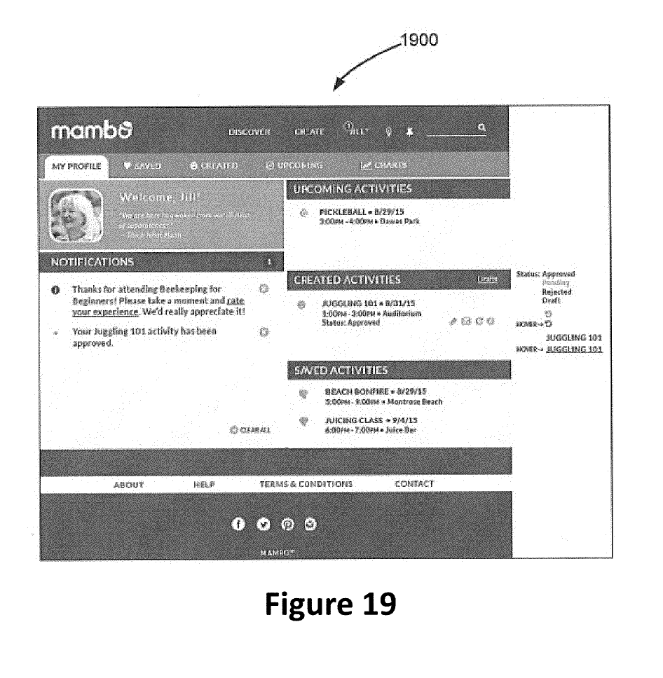

At any time, a registered user may elect to view their profile, as shown in FIG. 19. As can be seen, the profile in the illustrated example includes the user's saved activities, created activities, and upcoming activities. In addition, the illustrated profile includes notifications. In particular, the user has received a thank you for attending an activity (Beekeeping for Beginners) and an invitation to rate the activity.

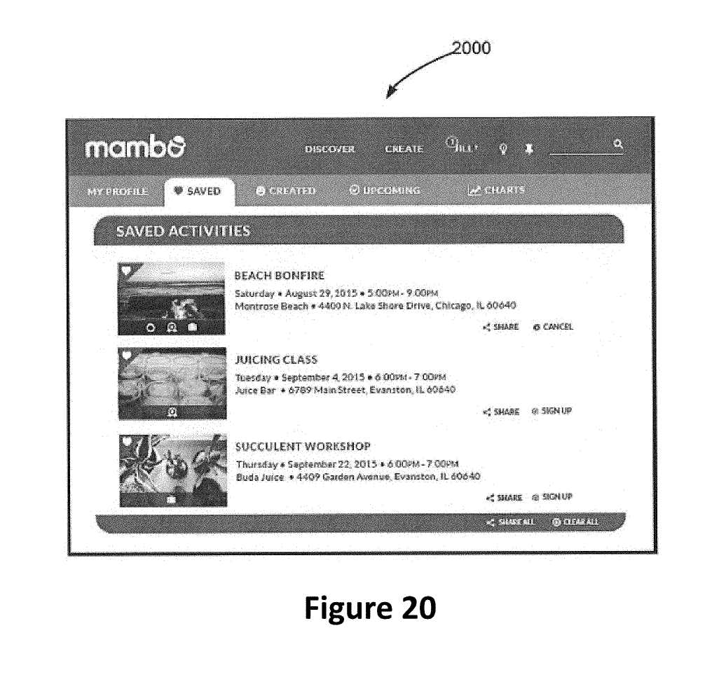

If the user selects the Saved Activities tab at stage 221, the user interface is as shown in FIG. 20. In particular, the Saved Activities view 2200 shows a listing of activities that are of interest to the user, e.g., “Beach Bonfire,” “Juicing Class,” and “Succulent Workshop.”

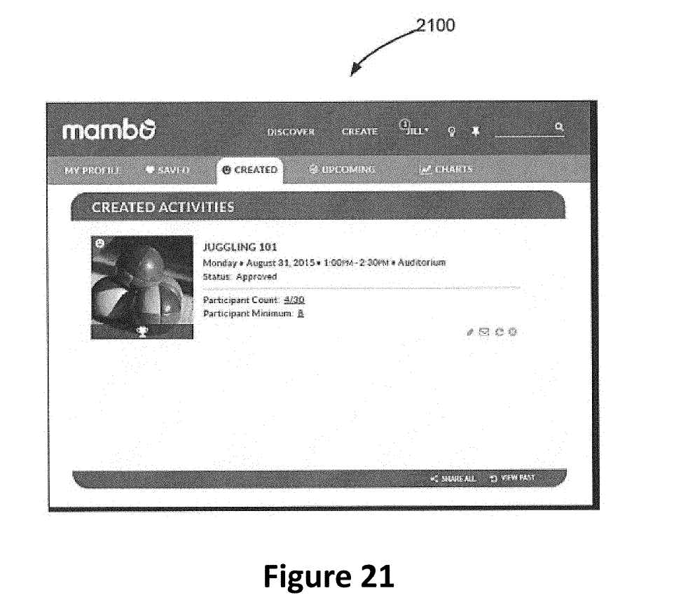

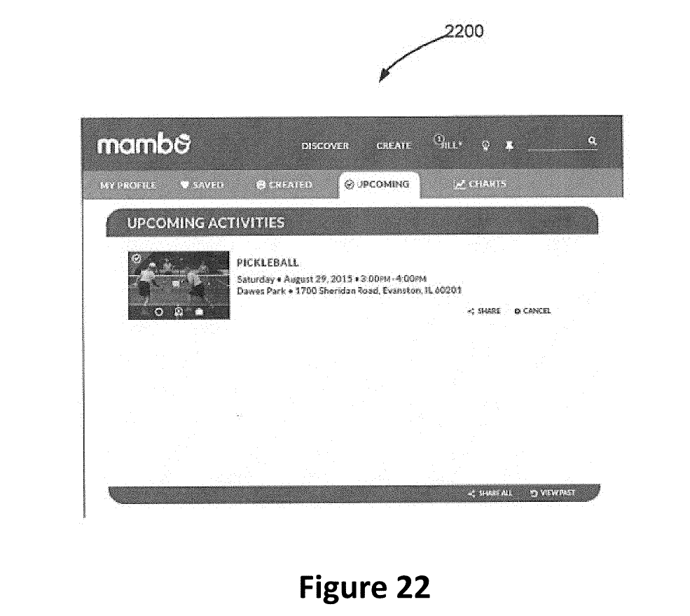

If the user selects the Created Activities tab at stage 223, the user interface is as shown in FIG. 21. In particular, the Created Activities view 2100 shows a listing of activities that the user has created, i.e., “Juggling 101” in the illustrated example. “Similarly the Upcoming Activities tab shows the user upcoming activities for which they have signed up, e.g., Pickleball, as shown in FIG. 22.

Of course, from within the Profile view, the user is also able to enter and edit personal information such as name, email, and so on as shown in the screenshot 2300 of FIG. 3. It will be appreciated that much of this information may have been entered initially during sign up.

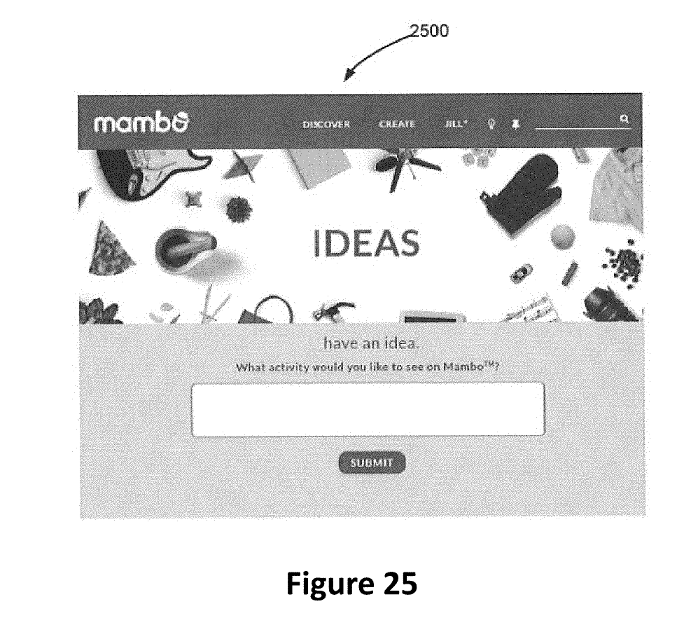

It was noted above that the described platform may also serve to provide alerts to users, both with respect to normal scheduled events and emergency situations. The screenshot 2400 of FIG. 4 shows one non-limiting example of such an alert, informing the user of a severe flash flood warning. An example of an idea submission screen is shown in FIG. 25.

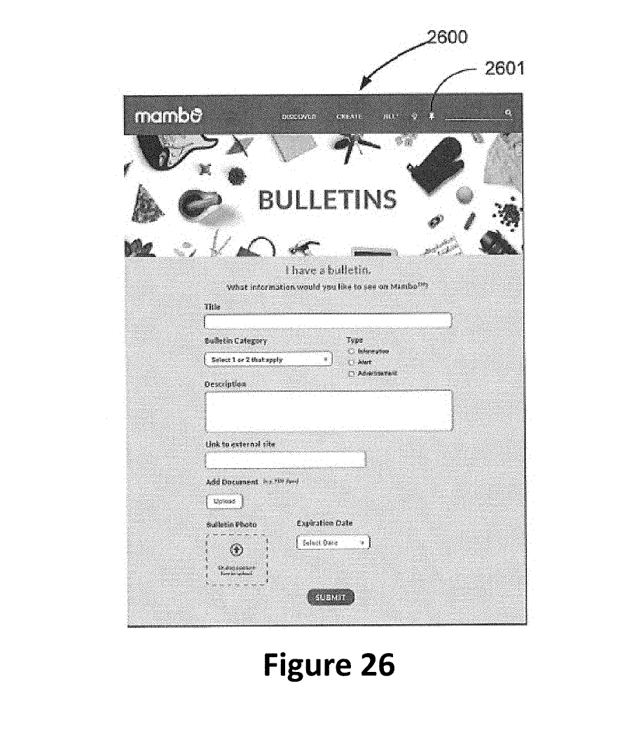

Furthermore, as noted above, the user may select the appropriate information icon 613, shown in FIGS. 6 and 7, to post a bulletin to the community. Selection of the Push Pin icon 2601 in any screen serves to pull up a bulletin window as shown in the example 2600 of FIG. 26. The user may then type and select bulletin information in fields such as Title, Category, Description, and so on. When finished, the user may select Submit, allowing the bulletin to be posted for other community members to see. Moreover, the bulletin window may be used as an additional or alternative method to provide alerts to users. The desired alert, both with respect to normal scheduled events and emergency situations, can be entered into the bulletin window and distributed within the designated categories. In some cases, the alert may be formatted with bold text, colored text, or other such formatting to draw attention to the alert. For example, alerts may be posted in red font and in all caps and placed at the top of the postings for the designated category; however, other formats and placements of the alerts may be possible.

In some embodiments, the scheduling application and administrative interface may include a user customizable notification tab or menu. Under the notification tab the users may be able to select a preferred method of notification such as text message, banner notification, email message, or other such notification method. Moreover, the notification tab may be configured to allow users to select and/or filter the desired information they would like sent or pushed by the preferred method of notification. Information the users may configure to be sent by the preferred notification method may include information related to a specific category, information related to a specific keyword, reminders for upcoming events, and other such information.

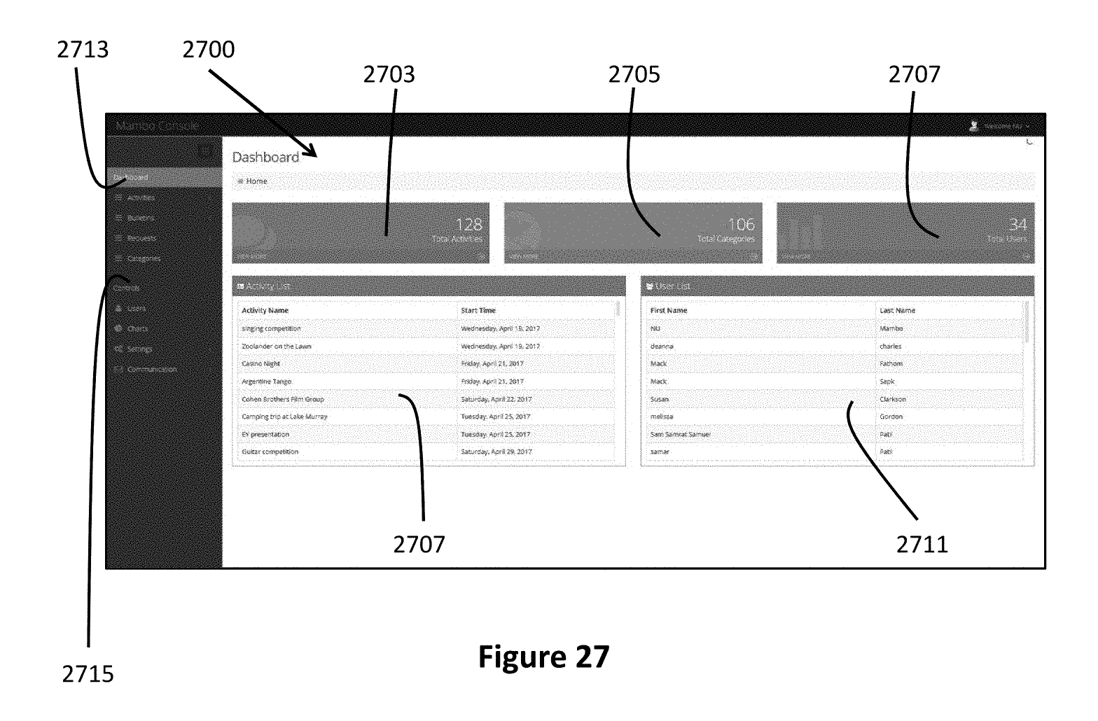

As noted above, one or more Administrators may have access to the scheduling application and administrative interface. The screenshot 2700 of FIG. 27 shows an exemplary display of the administrative interface used by the Administrator. Referring back to FIG. 1, the scheduling application and administrative interface may be stored on the server 101. The Administrator may access the administrative interface, shown on screenshot 2700, using the administrative device 109 that is communicably coupled to the server 101.

When the Administrator accesses the administrative interface via the administrative device 109 and the server 101, the Administrator may view a home page 2701 that is configured to display relevant information to the Administrator. In some cases, the Administrator may first be taken to a log in screen, and prompted to first enter the Administrator username and password in order to log into the administrative interface. Once logged in, the Administrator may then be taken to the home page 2701 of the administrative interface, such as screenshot 2700 shown in FIG. 4. In one non-limiting example, the home page 2701 is configured to display a summary of total activity count 2703, total category count 2705, and total number of users 2707. Furthermore, the home page 2701 displays an Activity List 2709 and a User List 2711; however the Administrator may alternately configure the home page 2701 to display summary counts, summary lists and other such information as desired.

Additionally, the home page 2701 includes a series of Dashboard tabs or buttons 2713 and a set of Control tabs 2715 arranged along the left boarder of the home page 2701. For example, the Dashboard tabs 2713 may include an Activities tab, a Bulletins tab, a Requests tab, and a Categories tab. Furthermore, the Control tabs 2715 may include a Users tab, a Charts tab, a Settings tab, and a Communications tab. Other tabs may be added by the Administrator to organize and store data and information as needed. Furthermore, the home page 2701 may be alternately arranged to display the tabs in different locations on the home page 2701. Additionally, the home screen may be alternately formatted to collect, organize and display information related to the scheduling application and administrative interface, as needed.

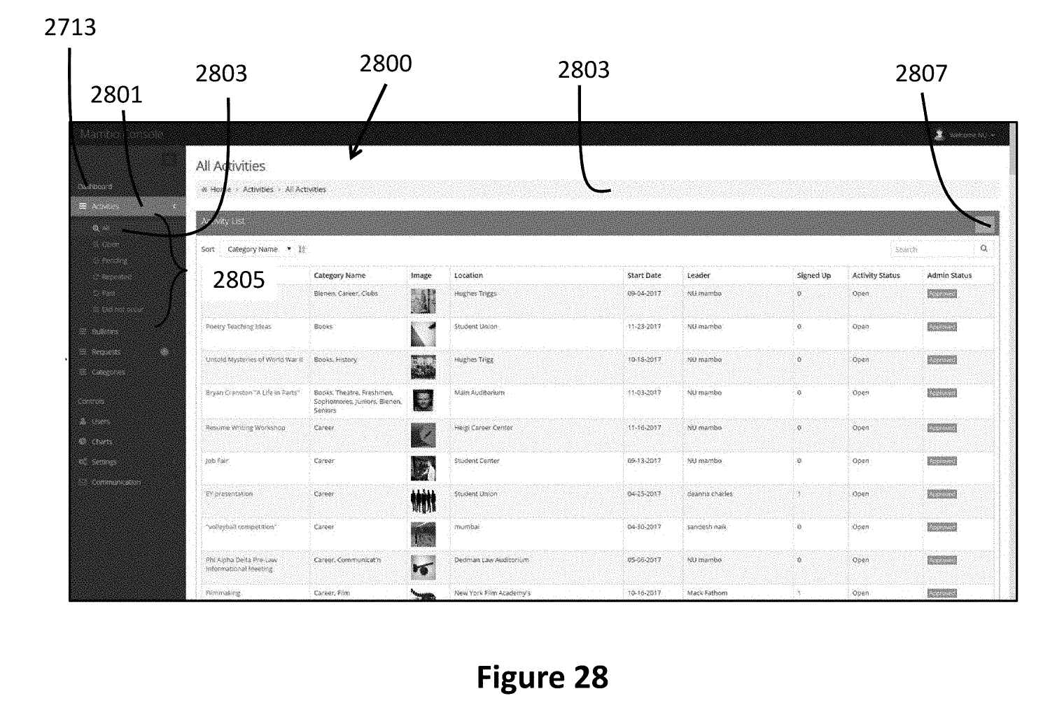

When logged into the administrator interface the Administrator may select one of the Dashboard tabs 2713. For example, as shown in screenshot 2800 of FIG. 28, the selection of the Activities tab 2801 may cause the administrator interface display a table of information, such as but not limited to an All Activities Summary Table 2803. Furthermore, once the Activities tab 2801 is selected a series of sub-tabs 2805 related to the Activities tab 2801 may be displayed. In the example shown in FIG. 28, the sub-tabs 2805 include All, Open, Pending, Repeated, Past, and Did not Occur; however additional sub-tabs 2805 may be added by the Administrator, as desired.

In one non-limiting example, selecting the sub-tab 2805 labeled All will display the All Activities Summary Table 2803. As shown in FIG. 28, the All Activities Summary Table 2803 includes numerous columns (Activity Name, Category Name, Image, Location, Start Date, Leader, Signed up, Activity Status, Admin Status) and rows that organize and display the information about each activity or event. The Administrator may add activity information by selecting the + icon 2807 and the Administrator may also delete information from the All Activities Summary Table 2803. Furthermore, the Administrator may filter the information displayed in the All Activities Summary Table 2803 to display certain information and hide other information. Selecting other sub-tabs 2801 will display similar summary tables related to the specific sub-tab 2801 that is selected.

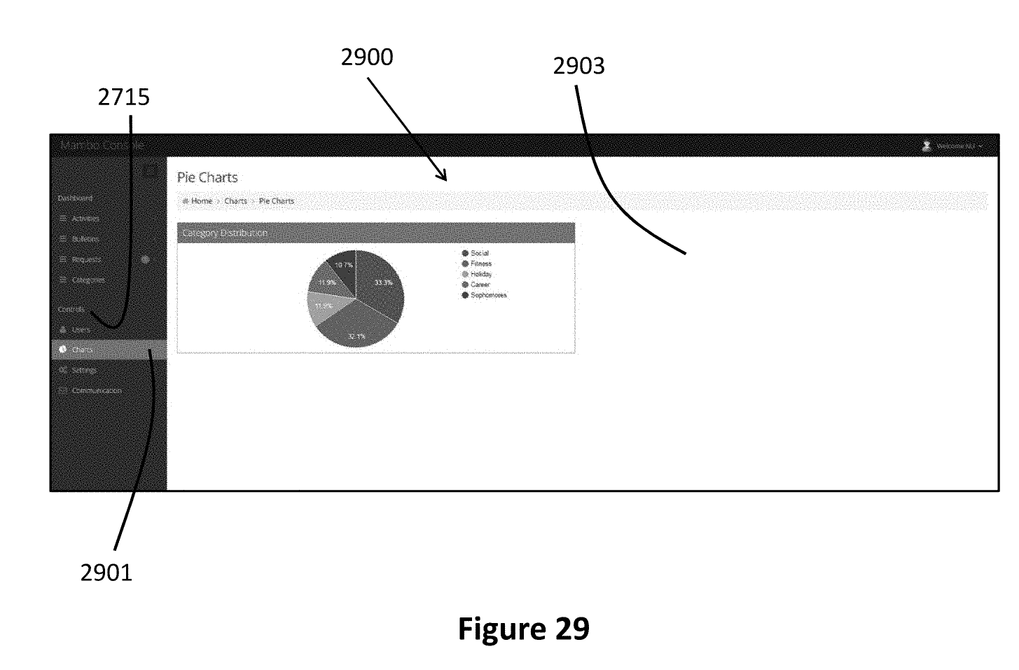

Returning to FIG. 27, a set of Control tabs 2715 such as but not limited to, Users, Charts, Settings, and Communications are also displayed on the home page 2701. The Administrator may use the various Control tabs 2715 to filter, analyze data, modify settings, or other such tasks related to the administrator interface. In the example shown in screenshot 2900 of FIG. 29, selection of the Charts tab 2901 will display a Pie Chart graphic 2903 that illustrates the category distribution of scheduled events. In this case, the category distribution includes Social, Fitness, Holiday, Career, and Sophomores. However, the Administrator may perform an alternative analysis on the scheduled events to summarize the data as desired. Additionally, the Administrator may generate an analytics report based off the analysis performed on the data contained in the scheduling application and administrator interface. The analytics report may be used by the Administrator, or other individuals in the setting up and scheduling of events.

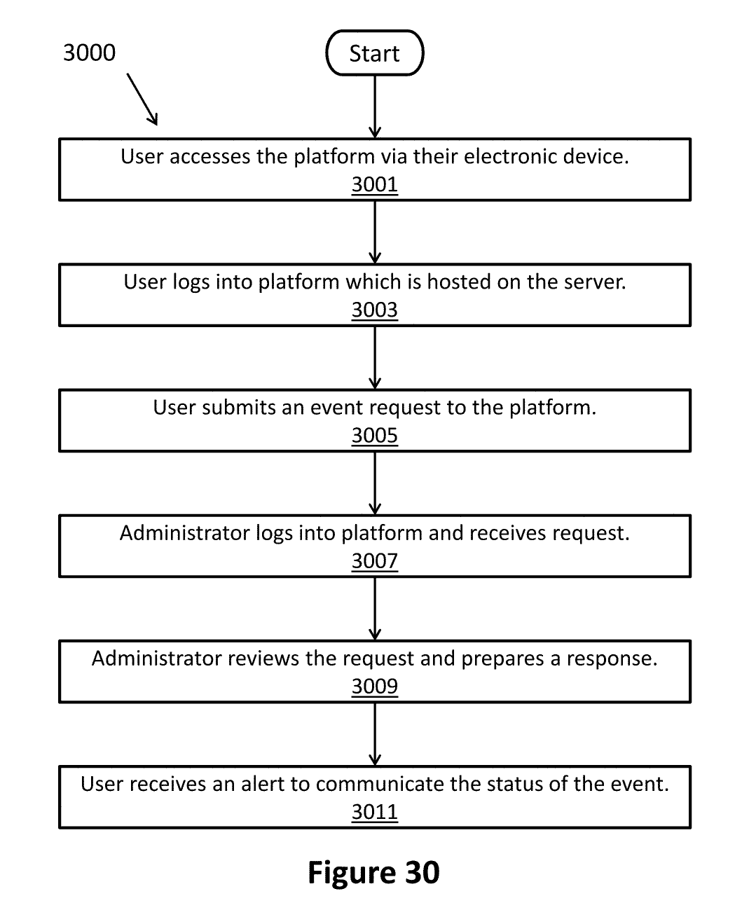

To this end, FIG. 30 provides a method or process 3000 for scheduling an event and informing a group of individuals about the event. At stage 3001 of the process, the user accesses the platform via their electronic device and lands on the home page 300 such as is shown in FIG. 3. Next, at stage 3003 the user logs in, assuming they have already registered, i.e., created an account on the system. If the user needs to create an account, the process is similar to traditional processes in that the user provides some basic information as well as a username and password. Furthermore, the platform, in this case the scheduling application and administrative interface, is hosted on the server 101 and the user logs on over the network using their electronic device 103, 105, 107, 109.

Once the user has logged in, the platform may direct the user to their home page, such as screen 600, illustrated in FIG. 6. From the home page, or any other platform page being viewed, the user can click on the Create tab 615 to submit an event request to add or schedule an event on the platform. After clicking on the Create tab 615, the user may be taken to a screen which prompts the user to input information about the event request. Event information may include but is not limited to, event name, event category, event date(s), minimum/maximum number of participants, and other such information. Once the initial information is input, the event request may prompt the user for additional information such as, the event location, the event description, and any other information that is related to scheduling and hosting the event. Once the user is finished inputting all of the event information, the event request is submitted at stage 3005 the Administrator.

The Administrator may log into the platform, at stage 3007, and receive the event request that was submitted by the user. In one embodiment, once logged into the administrative interface, the Administrator may view the administrative home page 2701, as shown in FIG. 27. The Request tab located under the Dashboard tab 2713 may alert the Administrator to the newly submitted event request that is waiting for review.

In a next stage 3009, the Administrator may open the Requests tab under Dashboard tab 2713 to view the submitted event request. The Administrator may then review the request and determine if all of the required information has been entered by the user. The Administrator may send an initial response to the user, or submitter of the event request, if additional information is needed. The Administrator will then review the event request to determine whether the event should be added to the platform or not. In making the determination whether to schedule the event or not, the Administrator may consider information such as but not limited to, the type of event, the cost of the event, feedback received from similar, prior events, and other such information.

After the Administrator has finished the event request review, then in a next stage 3011, an alert or other such response may be sent to the user that submitted the event request. The alert may be an electronic mail message, a text message a platform notification, or other such message. Moreover, the alert may communicate a status of the event, such as the acceptance or denial of the event request. If the event request has been denied the user that submitted the event request may modify the event request and try again.

In the case that the event has been accepted, the alert may be sent or otherwise communicated to other platform users about the newly scheduled event. In some embodiments, the alert can be sent to all of the active platform users. Alternatively, the alert can be sent to a subset of platform users. For example, the alert may be sent to users that request to be notified about events that fall into the specific category as the newly scheduled event. Furthermore, the list of users may be identified by the user that submitted the event and the user can request the Administrator to user this list for communicating or distributing the alert. Once the alert has been sent out, the group of individuals may begin to register or sign-up for the newly added alert.

It will be appreciated that a system and method for improved community activity and resource coordination have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A system for informing a group of individuals, each individual having access to an electronic computing device for accessing data over a network, the system comprising:
a server hosting a scheduling application and administrative interface configured to receive information regarding one or more events available to the group of individuals, post the one or more events for viewing over the network by one or more individual of the group of individuals, allow any individual of the group of individuals to submit a suggested event for posting by the scheduling application and administrative interface, and allow any individual of the group of individuals to sign up for any posted event from their electronic computing device via the server; and
an administrative module associated with an administrative electronic computing device, the administrative module being configured to expose the scheduling application and administrative interface to an administrative personnel to allow such personnel to create at least one of a filter, a modified description, and a posting that interacts with any suggested event.

2. The system in accordance with claim 1, wherein the scheduling application and administrative interface is further configured to provide each individual of the group of individuals with an event alert for the one or more events for which they have signed up.

3. The system in accordance with claim 1, wherein the scheduling application and administrative interface is further configured to provide each individual of the group of individuals with an emergency alert.

4. The system in accordance with claim 1, wherein the scheduling application and administrative interface is further configured to allow any individual of the group of individuals to post a photo for an event posting created by that individual.

5. The system in accordance with claim 1, wherein the scheduling application and administrative interface is further configured to allow any individual of the group of individuals to post at least one of a description, a fee requirement, a category, a minimum number of participants, and a maximum number of participants for the event posting created by that individual.

6. The system in accordance with claim 1, wherein the scheduling application and administrative interface is further configured to provide an evaluation form to allow an event participant to rate the event.

7. The system in accordance with claim 1, wherein the administrative module is further configured to provide an event analysis interface allowing the administrative personnel to generate an analytics report regarding the one or more events.

8. A method of scheduling an event and informing a group of individuals about the event, each individual capable of sending and receiving data related to the event over a network, the method comprising:
connecting an electronic computing device to the network;
hosting a scheduling application and administrative interface on a server that is accessed by the electronic computing device over the network;
submitting an event planning request by an individual of the group of individuals to the scheduling application and administrative interface;
accessing the scheduling application and administrative interface by an administrative personnel to receive the event planning request;
determining by the administrative personnel to schedule the event in the scheduling application and administrative interface based on a review of the event planning request; and
displaying an event alert based on the review of the event planning request and the event alert is configured to communicate an event status to the group of individuals.

9. The method in accordance with claim 8, wherein the event planning request includes at least one of an event description, an event fee, an event category, a minimum number of participants, and a maximum number of participants.

10. The method in accordance with claim 8, wherein determining to schedule the event includes notifying an event organizer an event scheduling acceptance or an event scheduling denial.

11. The method in accordance with claim 8, wherein displaying the event alert includes sending an event sign up form to the group of individuals.

12. The method in accordance with claim 8, wherein displaying the event alert includes sending an emergency alert to the group of individuals.

13. The method in accordance with claim 8, further comprising sending an event evaluation form to the group of individuals to provide an evaluation of the event attended.

14. The method in accordance with claim 13, further comprising analyzing the event evaluation form by an administrative module, wherein the administrative module creates an analytics report based on responses received from the event evaluation form.

15. A device for informing a group of individuals about an event, each individual having access to an electronic computing device that is communicably coupled to the device, the device comprising:
a storage module;
at least one processing unit coupled to the storage module;
a scheduling application and administrative interface executed by the at least one processing unit, the scheduling application and administrative interface configured to:
receive information regarding one or more events available to the group of individuals;
post the one or more events over a computer network for viewing by the group of individuals and allow each individual to sign up for the one or more events from their electronic computing device;
allow any individual of the group of individual to submit a suggested event for posting by the scheduling application;
post the suggested event on the scheduling application and allow any individual of the group of individuals to sign up for the suggested event from their electronic computing device; and
display the administrative interface to an administrative personnel and allow the administrative personnel to create at least one of a filter, a modified description, and a posting that interacts with any posted event or the suggested event.

16. The device in accordance with claim 15, wherein the scheduling application and administrative interface is further configured to provide each individual of the group of individuals with an event alert for the one or more events for which they have signed up.

17. The device in accordance with claim 15, wherein the scheduling application and administrative interface if further configured to provide each individual of the group of individuals with an emergency alert.

18. The device in accordance with claim 15, wherein the scheduling application and administrative interface is further configured to allow any individual of the group of individuals to post at least one of a description, a fee requirement, a category, a minimum number of participants, and a maximum number of participants for the suggested event created by that individual.

19. The device in accordance with claim 15, wherein the scheduling application and administrative interface is further configured to provide an evaluation form that allows an event participant to evaluate the event.

20. The device in accordance with claim 19, wherein the administrative interface is coupled to an administrative module and the administrative interface allows the administrative personnel to generate an analytics report based on the evaluation form received from the event participant.
